(19) United States
(12) Patent Application Publication
(10) Pub. No.: US 2002/0007324 A1
(43) Pub. Date: Jan. 17, 2002

(54) System and method for effectively conducting transactions between buyers and suppliers

(76) Inventors: David J. Centner, Great Neck, NY (US); Richard Chusid, Westbury, NY (US); Robert G. Heller, Roslyn, NY (US)

Correspondence Address: SCULLY, SCOTT, MURPHY & PRESSER, 400 Garden City Plaza, Garden City, NY, 11530, US

(21) Appl. No.: 09/878,087

(22) Filed: Jun. 8, 2001

Related U.S. Application Data
(60) Provisional application No. 60/210,883, filed on Jun. 9, 2000.

(51) Int. Cl. G06F 17/60

(52) U.S. Cl. 705/26

(57) ABSTRACT

A web-based service that facilitates communications and commercial transactions between buyers and suppliers, including the efficient distribution of a buyer's request-for-quotations (RFQs) to an audience of that buyer's preferred suppliers, and the automatic and efficient handling of supplier quotations in a variety of bidding formats that are communicated back to the buyer for selection of a winning bid. After selection of the winning bid, a server device generates communications for enabling the buyer and winning supplier to enter into a contract for completing the commercial transaction.

### CROSS-REFERENCE TO RELATED APPLICATIONS

The following patent application claims the benefit of U.S. Provisional Patent Application Ser. No. 60/210,883, filed Jun. 9, 2000.

### BACKGROUND OF THE INVENTION

1. Field of the Invention

The invention relates to a system and method for conducting commercial transactions, and in particular, to a system and method for facilitating communications and transactions between buyers and suppliers.

2. Discussion of the Prior Art

Typically, a buyer, e.g., a purchasing manager in an industry, has a set of “preferred suppliers” of goods, services, and/or materials for manufacture of goods. Such preferred suppliers sometimes are also referred to by businesses as “approved vendor lists” or “trading partners”. In some cases, a supplier is classified as “preferred” by the buying organization because of the supplier's adherence to the buying company's standards of quality, delivery, systems, processes, or other criteria or combination of criteria. In other cases, a supplier maintains a preferred status because of a long-standing relationship with the buying organization. In still other cases, a buyer may desire to have a relationship with a particular supplier, but has not had occasion or ability to do so yet. In any event, this designation may be official or unofficial to the buying organization.

In most organizations, when a buyer has a need to procure or purchase a product or service, the buyer must create an official request-for-quotation (“RFQ”) or request-for-proposal (“RFP”) document, designed to be distributed to each individual supplier. The information contained in the RFQ may be released via fax, e-mail, telephone, or other communication means. When a supplier is in receipt of the RFQ, it submits a competitive bid or a series of refined competitive bids to the buyer for review and ultimate selection of a winning bid. This process is typically labor intensive, and oftentimes does not result in an efficient competitive bidding event. As a result, the buyer becomes inclined to oversee an undesirably small number of supplier relationships.

With the advent of the Internet, allowing increasingly secure and reliable communications therethrough, websites have been specially designed to facilitate transactions between buyers and suppliers in a business-to-business context.

While buyers find the aforementioned prior art transaction websites attractive because of the promise of reduced prices accompanied by a streamlined procurement process resulting in reduced purchases and process costs, there are recognized deficiencies of such transaction websites, stemming from their inherent inability and difficulty by the buyer to specify with great accuracy and detail the buyer's preferred trading partners. Thus, in the prior art, the buyer utilizes the transaction websites merely as an efficient means for transacting with the suppliers with which they are already comfortable.

Further, while technology exists in the supply chain management (SCM) category, which permits for buyers to have this precision with regard to trading partners, in all cases the buyers and suppliers must adopt technology solutions, usually from the same technology solution provider before they can facilitate transactions with each other.

It would be highly desirable to provide an Internet/World-Wide-Web based system and methodology that creates commercial transaction efficiencies by streamlining the product/service procurement process between buyers and suppliers of goods and services.

It would be further highly desirable to provide a system and method that overcomes the prior art limitations by allowing for buyers to designate with specificity and accuracy its preferred suppliers during product/service procurement process, while at the same time requiring no technology implementation by the supplier nor the buyer other than access to common communication platforms.

### SUMMARY OF THE INVENTION

Accordingly, it is an object of the present invention to provide a web-based service and methodology that creates efficiencies for buyers and sellers entering into commercial transactions.

It is another object of the present invention to provide a web-based service and method that streamlines the product/service procurement process between buyers and sellers of goods and services and that overcomes the prior art limitations by allowing for buyers to designate with specificity and accuracy its preferred suppliers during product/service procurement process, while at the same time requiring no technology implementation by the supplier nor the buyer other than access to common communication platforms such as the Internet and e-mail.

It is a further object of the present invention to provide a web-based service that facilitates a streamlined bidding process whereby the buyer may choose from a selection of RFQ bidding formats, and that enables suppliers designated by the buyer, to more efficiently submit bids, refine bids, and monitor competitive bids up until a buyer-specified RFQ deadline date and time.

It is yet another object of the present invention to provide a web-based service that enables a buyer flexibility in optionally supplementing their preferred suppliers list with additional suppliers that are not necessarily pre-approved suppliers for purposes of soliciting additional bids which allow for greater competitive pricing pressure from the preferred suppliers, as well as the potential of identifying new sources of supply which may eventually become official preferred suppliers of the buying organization.

According to the principles of the invention, there is provided a system and method for conducting commercial transactions between buyer and sellers, the system comprising a server device capable transmitting web-based communications for receipt at web browser devices associated with buyers and suppliers, a communication being downloaded from the server including entries enabling a buyer to initiate a request for quotation (RFQ) bidding event for soliciting bids from suppliers of a requested product to be purchased by a buyer and, selecting preferred suppliers capable of providing the requested product based on a product description; a mechanism for automatically generating one or more electronic communications notifying selected suppliers of the RFQ bidding event, a communication being downloaded from the server to selected suppliers for enabling each selected supplier to submit a bid for the product to be purchased; and, a mechanism for receiving said submitted supplier bids of said RFQ bidding event and providing a further communication to the buyer for enabling selection of a winning bid, the mechanism for automatically generating one or more electronic communications further notifying a selected winning supplier, whereby in response to selection of a supplier with said winning bid, the server generates further communications for enabling the buyer and winning supplier to enter into a contract for completing the commercial transaction.

In an illustrative embodiment, a buyer desiring to purchase goods, services and/or materials utilizes an automated and perhaps anonymous communication means such as the Internet to conduct transactions. In this embodiment, a secure controller is employed whereby the buyer can input and store the identities of the buying party's preferred suppliers.

In addition, the buyer may also utilize the same, or perhaps similar automated and anonymous communication means which, when working in conjunction with the controller, allows the buyer to efficiently distribute request-for-quotations (RFQs) to an audience of that buyer's preferred suppliers, and to automatically and efficiently enable supplier quotations in a variety of formats.

The application of the invention is not limited to only the Internet, but other mediums facilitating automated communications between buyers and suppliers in business-to-business and business-to-consumer environments. Advantageously, to realize the invention, no technical integration or software installation at any client party, i.e., buyer or seller, is required. Thus, the invention fundamentally improves the above-described supply chain management (SCM) technology.

### BRIEF DESCRIPTION OF THE DRAWINGS

Further features, aspects and advantages of the apparatus and methods of the present invention will become better understood with regard to the following description, appended claims, and accompanying drawings where:

FIG. 1 illustrates an arrangement for conducting transactions between buyers and suppliers in accordance with the invention;

FIG. 2 is a flow chart depicting a process of creating a database of selected suppliers and utilization of such a database in accordance with the invention;

FIG. 3 is a flow chart depicting a process of gathering suppliers to attend to an RFQ event; and

FIGS. 4(a)-4(e) is an exemplary illustration of the process of conducting a transaction concerning a product or service according to the principles of the invention.

FIGS. 5(a)-5(d) illustratively depict example web-based communications related to certain aspects of the procurement transaction process flow according to the invention.

### DETAILED DESCRIPTION OF THE PREFERRED EMBODIMENT

The present invention is a web-based service that creates transaction efficiencies by streamlining the product/service procurement process between buyers and suppliers of goods and services. Particularly, the web-based service implements methodology that enables buyers to selectively define their preferred suppliers in the procurement process, and a system and method for efficiently communicating requests-for-quotation (RFQs) to the selected suppliers. The service furthermore facilitates the submission of competitive bids by the supplier organization, and the eventual selection of the winning competitive bid. Through the entire process for both buyers and suppliers, no special technical integration is required, except for the implementation of conventional web-browser software that enable users of the system common access to a web-server controller device and the ability to receive communication via common devices such as e-mail.

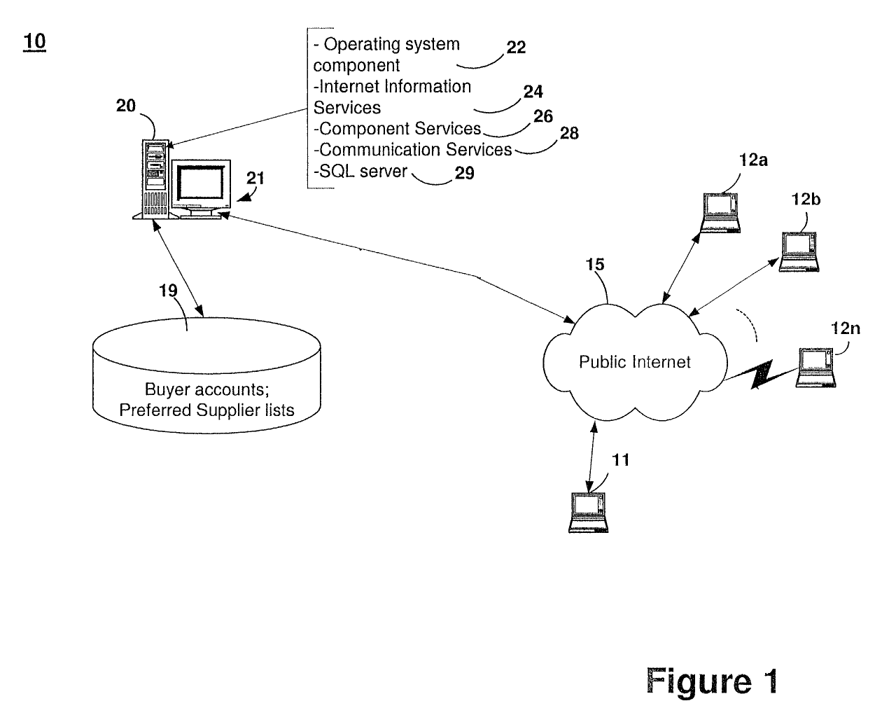

FIG. 1 illustrates the system 10 embodying the principles of the invention for conducting procurement transactions between buyers and suppliers according to the principles of the invention. More particularly, FIG. 1 illustrates an Internet/Web-based communications network established for enabling a buyer desiring to purchase goods, services and/or materials to utilize the Internet 15, or like wired or wireless networked environment (e.g., telephone system, wireless mobile device system, or other communications network) to conduct the procurement transactions. The buyer may use buyer computer device 11 to communicate with a secure computer, i.e., “controller” device 20, connected to the Internet 15 at a predetermined uniform resource locator (URL) or website 21 over a secure communications link, e.g., secure sockets layer, or similar protocol. To that end, buyer computer 1, e.g., a personal computer, may run thereon conventional web browser software, e.g., Netscape® or Internet Explorer 5.0®. In accordance with the invention, the Buyers who subscribe to the service inputs and stores the identities of the buying party's preferred suppliers in the controller database 19 in a manner described below. In addition, the buyer may also utilize the controller 20 to efficiently distribute request-for-quotations (RFQs) to an audience of that buyer's preferred Suppliers, depicted in FIG. 1 as Suppliers 12a, . . . , 12n, and to automatically and efficiently enable Supplier quotations in a variety of formats.

In this illustrative embodiment depicted in FIG. 1, controller 20 may be a conventional computer(s) or server device employing hardware and software components including those configured to facilitate database query and web-page and electronic communication among parties including, but not limited to: 1) an Operating System (OS) component 22, e.g., such as Microsoft Windows or Windows NT, that is utilized in all computers in the production network to provide the basic software platform upon which all other software mechanisms operate; and, a database memory component 19 for storing Buyer account information and associated preferred Supplier profiles; 2) application server components including: Internet Information Services (IIS) 24 which provides mechanisms enabling files on a computer to be read by remote computers and particularly, is used to house, secure and present a web site to either the Internet or an intranet (private network); Component Services 26 which function as a repository of custom Dynamic Link Libraries (dli's) that allow custom applications to perform actions in data sources foreign to the application, e.g., enabling a web page to query data on a database, or create a new Buyer account; and, Communication Services 28 which include a server applications that enable various electronic communications including, but not limited to: e-mail, facsimile, etc. Other software applications that may run include SQL database server software 29, such as provided by Microsoft, that enables database query and lookup and provide matching functionality when selecting suppliers to participate in an RFQ bidding event as will be described in further detail herein.

To fully appreciate the invention, a two-part automated methodology in accordance with the invention will now be described.

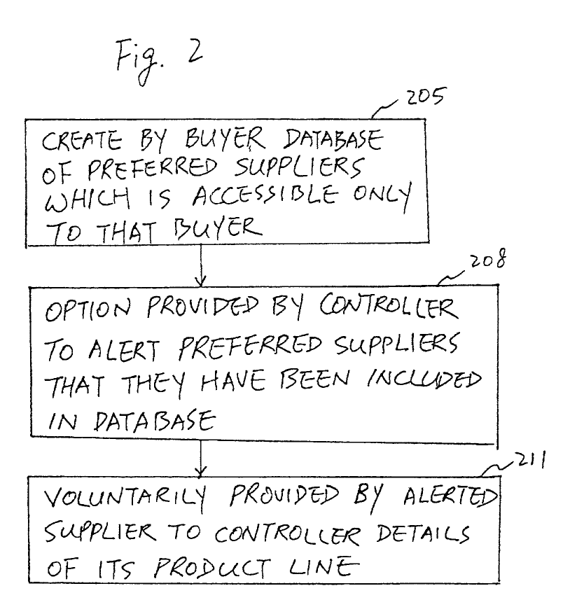

The first part is directed to the creation of the Preferred Supplier Database now described with reference to FIG. 2. As shown in FIG. 2, as indicated at step 205, the Buyer creates and stores a database of preferred suppliers available which is accessible only to that buyer. This may be accomplished using a form downloaded to the Buyer by the controller 20 via the Internet 15 whereby the buyer types in certain identifying characteristics of each buyer, including, but not limited to, company name, individual name, e-mail address, phone number, address, etc. This information is stored securely in a centralized file storage device, e.g., database 19, within controller 20. The buyer does this procedure consecutively for each preferred supplier until the buyer has created a complete database comprising records of all or some of its preferred suppliers.

Alternatively, as will be appreciated by skilled artisans, the Buyer may create this database by uploading to controller 20 a file (spreadsheet, database, or other digital file) containing the details for all preferred suppliers. The file would need to be in a pre-defined format for proper uploading and subsequent acceptance by controller 20. The Buyer may additionally create this database by selecting specific suppliers from a larger, more comprehensive database which already resides in the database maintained by the controller 20. This may be accomplished through the use of sample query tools, such as provided by a search engine. Once a specific supplier is identified within the database, the buyer would have the ability to copy this record from the central database into the Buyer's private database.

Next, as indicated in FIG. 2 at step 208, the Buyer receives from controller 20 an option to have an automated communication be sent to the preferred suppliers via e-mail, fax or other communication means, to alert them that they have been included as a member of the Buyer's database of preferred suppliers, and that the Buyer may utilize controller 20 in the future as a means of efficiently distributing requests-for-quotation (RFQs) and receiving pricing from each supplier.

In response, as indicated at step 211, an alerted or invited Supplier 12a, for instance, may utilize his/her computer to voluntarily provide to controller 20 details of its product line in order to match up at a later point RFQ invitations with only those suppliers selling these items. It should be understood that some suppliers 12a, . . . , 12n may utilize other techniques to automatically deliver to controller 20 product line details and other information either on a one-time basis or a regularly recurring basis, such data to be delivered in a pre-defined format for proper uploading and subsequent acceptance by controller 20. It should be understood that some suppliers 12a, . . . , 12n may utilize other techniques to automatically deliver to controller 20 product line details and other information either on a one-time basis or a regularly recurring basis, such data to be delivered in a pre-defined format for proper uploading and subsequent acceptance by controller 20. Alternatively, the supplier may choose not to provide product line details to the website served by controller 160, and may simply reside as a record within a database of controller 160. Without registration, it should be noted that there may be no mechanism for matching up buyer-submitted RFQs with specific suppliers selling those items.

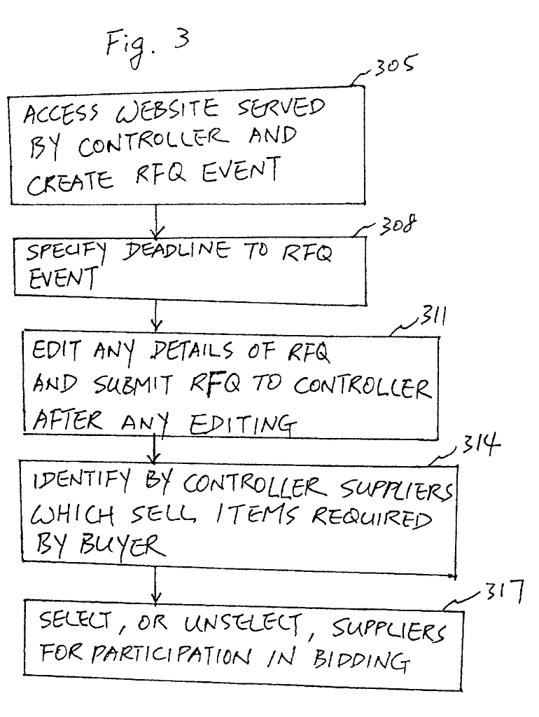

The second part is directed to the method for distributing Requests-for-Quotation to Preferred Suppliers as now described with reference to FIG. 3.

As indicated at step 305 in FIG. 3, when the buyer seeks to procure goods, services or materials, he/she accesses the website 21 served by controller 20 and creates an RFQ event for certain desired goods, services or materials by inputting the details of that Buyer's needs into a form provided by controller 20 over the Internet 15 (or other networked device). The data inputs include all the necessary attributes, specifications, and requested delivery of the goods or services desired in order for a seller to provide a price quote. As part of this information provided, is the desired deadline for the RFQ event that is specified either by the Buyer or automatically (as determined by the rules of the subject website), as indicated at step 308. In addition, the buyer has the option of designating this RFQ event as a single quote sealed-bid event, reverse auction, double quote, or any number of other RFQ bidding formats.

When the Buyer finishes inputting all the required information pertaining to his/her RFQ event, a confirmation screen appears allowing the buyer to edit any details of the RFQ, and otherwise enable the Buyer to submit the RFQ to controller 20 after any editing, as indicated at step 311. After the buyer submits the RFQ to controller 20, a web-page is generated by the controller 20 and downloaded to the Buyer computer 11 identifying all the buyer's preferred suppliers which sell the particular items requested by the buyer, as indicated at step 314. This is made possible by a software process that is executed at the controller 20 for matching the specifics of the RFQ data inputs with the Supplier information provided in that Buyer's preferred supplier database.

It should be understood that it is further possible to identify other suppliers that have not been designated as a preferred supplier to that buyer, and, therefore, offer the option to the buyer to expand their universe of suppliers for this particular RFQ event. Alternatively, if no supplier product line details exist with controller 160, the screen may simply identify a list of all the buyer's preferred suppliers, without regard to matching the RFQ needs with the specifics of the supplier's product lines.

As indicated at step 317, FIG. 3, the buyer then has the ability to select, or unselect, which preferred suppliers, non-preferred suppliers, or any combination thereof are to receive a communication, e.g., via e-mail or fax, inviting them to participate in bidding for the goods, services or materials the Buyer desires. Alternatively, the buyer has the ability to create and store a set of preferences or rules that apply to certain or all RFQ events. One such rule, for example, may include an instruction not to automatically send the buyers e-mails or faxes.

In another embodiment, the RFQ data may then immediately communicated via email, fax or other communication means without prior review by the Buyer to the preferred suppliers of that Buyer and/or other suppliers not designated as preferred suppliers by that buyer. In this communication, the details of the Buyer's needs, the auction deadline, and all relevant details are provided to all selected suppliers for review. Each supplier may then determine if it is amenable to participating in the RFQ event, taking into consideration the goods, services or materials requested, delivery requirements, the RFQ event rules, the supplier's inventory and all other aspects of the RFQ data. This decision may typically occur offline in a manual fashion. However, it may also occur utilizing rules-based agents interconnected with the suppliers pricing and inventory control systems. Thus, in an automated fashion based on pre-defined rules governing inventory state and payment terms, for example, this decision of whether the Supplier will participate in the event may be automatically determined. In the event the Supplier is amenable, it would post its first bid on the subject website 21 served by controller 20. This bid posting would typically occur manually, however, it is possible to utilize rules-based agents with strict price strategy parameters which may automatically submit bid quotations. That is, the supplier may be set up with a proxy-type bidding capability that will automatically make decision regarding pricing strategies going into an event, lowest price quotation, and amount of decrements (subject to bidding event rules proscribed) and automatically post the competitive bids to the service without any human intervention. At the same time, other Suppliers are making this subjective determination for themselves and they too, may post their own competitive bid on the subject website, either manually or automatically. It should be understood that the web-site may provide this service to the suppliers when they log in to the system. After each competitive bid is received by controller 20, controller 20 provides the supplier the supplier's ranking in relation to the other competitive bids. Alternatively, the suppliers can see the other competitive bids prior to their first posting. If the RFQ was set up initially by the Buyer as a single-quote sealed bid event, the RFQ event would conclude. Otherwise, based on the RFQ bidding rules, the Suppliers may re-evaluate their bids in relation to the other competitive bids prior to the auction deadline by either visiting the subject website, or receiving e-mail, faxes, or other communication means informing the suppliers of their bid ranking. The suppliers may then make a subjective determination to revise their bid relative to the other bids and the RFQ bidding rules, by posting another bid to controller 20. This process of posting and reposting occurs subjectively by each supplier invited to the auction until the RFQ event deadline occurs, or the RFQ bidding rules have been satisfied. At the auction deadline, the buyer visits the subject website, examines the bidding activity for the RFQ event, and selects a winning supplier from the list of competitive bids. Alternatively, the Buyer may have a pre-defined rule which automatically selects the winning supplier based upon price, delivery terms, or other criteria or combination of criteria.

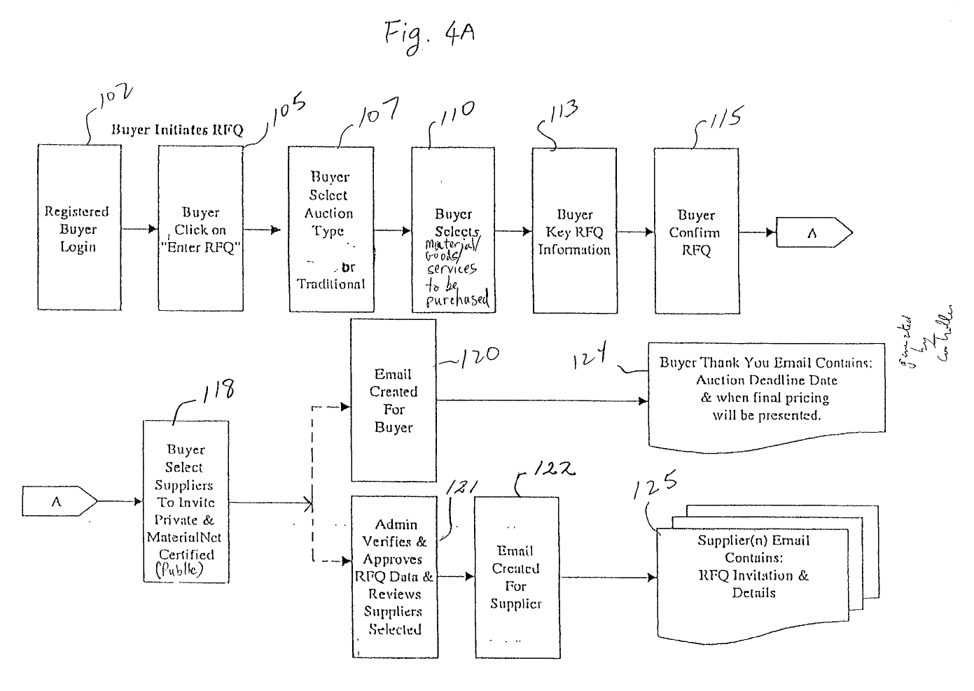

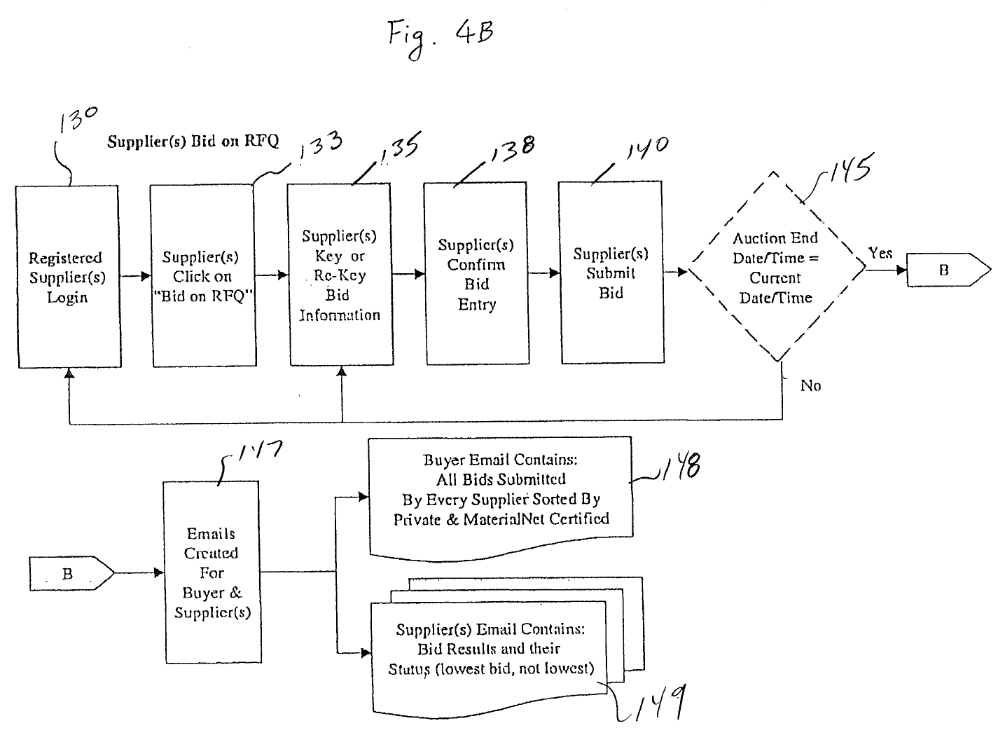

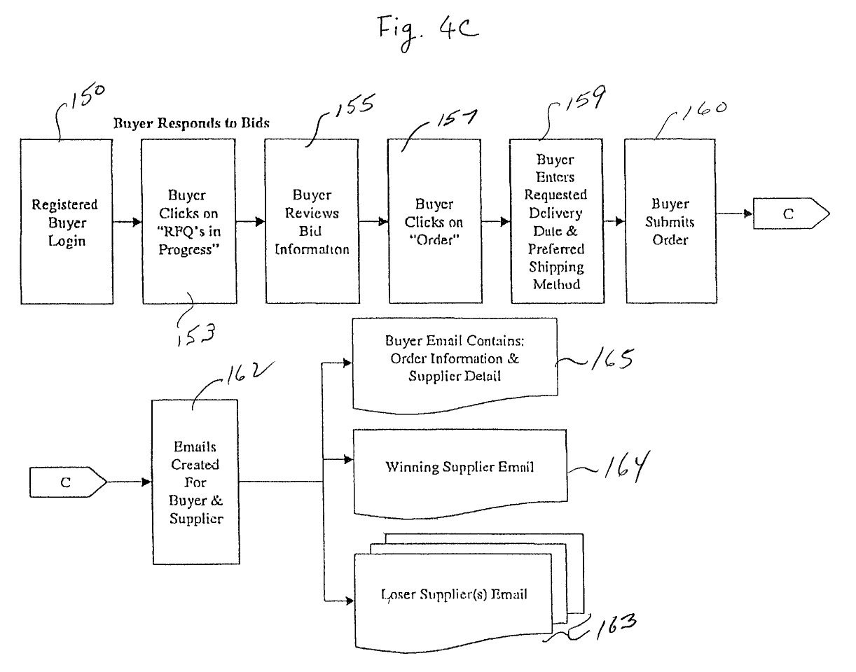

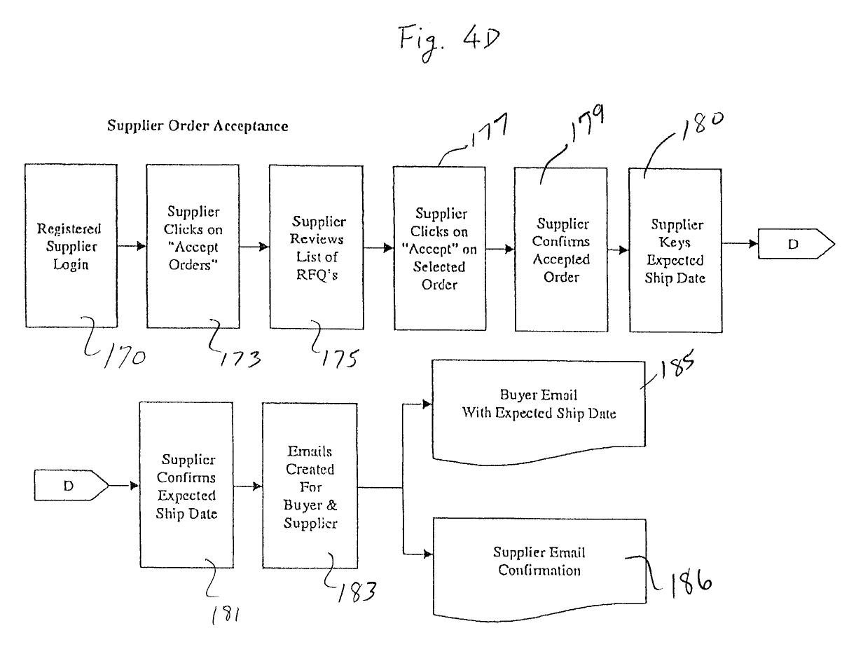

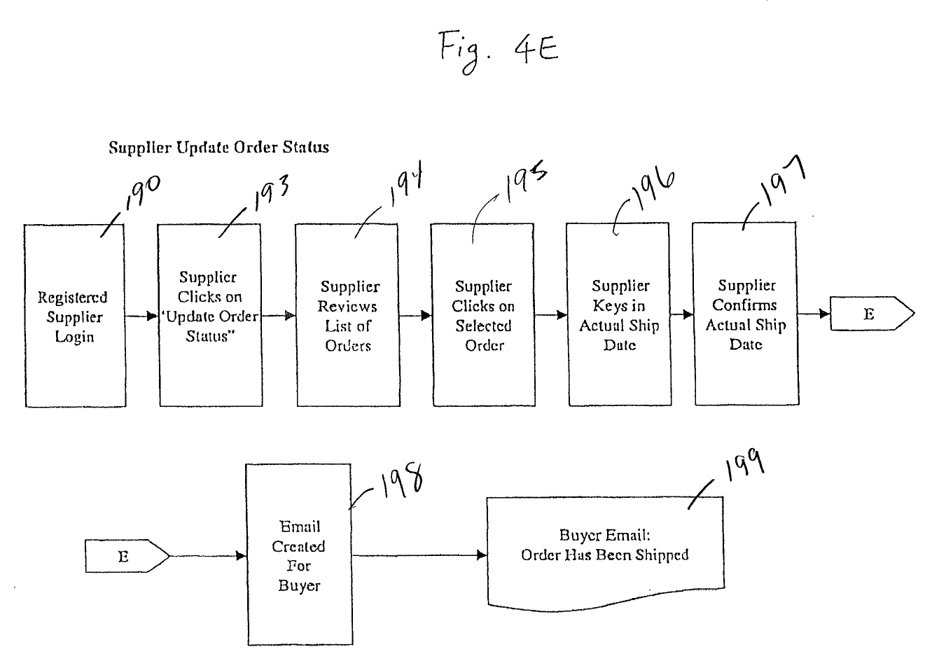

FIGS. 4(a) through 4(e) depict an example procurement transaction process flow diagram 100 highlighting the features of the invention as fully described herein. Based on the disclosure heretofore, the process illustrated in these figures for conducting a transaction concern any product or service.

As shown in FIG. 4(a) at a first step 102, a Buyer logs in to the web-service at step 102, and is provided with a web page providing a menu choice (not shown) enabling the Buyer to enter a request for quotation at step 105. Here, the Buyer selects the type of RFQ event, including, but not limited to: reverse auction, sealed-bid quotation, double-blind bid, and variations thereof, as indicated at step 107, and at step 110, selects the material/goods/or service to be purchased, e.g., die castings. Then, at step 1113, the Buyer may enter more details pertinent RFQ information including event name that, typically, is the requested product to be purchased, the event description field, the event start and end dates, the event duration, the event type, e.g., sealed bid or reverse auction, and some of the rules governing the event, description of materials required, and links available to upload attachments. Some common event rules that may be entered include, but are not limited to: price transparency rules, e.g., full—where each selected supplier may view all of the other suppliers bids above and below that supplier's bid; partial—where the supplier may only view only the rank of that persons' bid compared to others; or, other types of price transparency—where suppliers may view other supplier bids in a predefined manner; event durations; extension rules governing time extensions; opportunities for the Buyer to attach drawings/blueprints and/or contracts to the RFQ specifying terms and conditions that the supplier is to comply; minimum reserve rules for reverse auctions specifying the target price or better that will be acceptable to the Buyer; opening bid; ceiling prices; minimum decrement amounts for bidding; specification of price breakdown, e.g., specify prices according to material, delivery and other components, etc.

Continuing in FIG. 4(a), is a confirmation step 115 to test the logic of the data entered, e.g., if the web-based forms are filled out correctly. Then, at step 118, the Buyer will select the suppliers to invite, for example, from the list preferred suppliers who the Buyer frequently transacts with that is stored in the controller database, and/or from a list of public suppliers who sell the requested material that meet the criteria described in the RFQ and that are registered with the controller service. At this step, the controller 20 invokes a matching process to automatically match the suppliers and public suppliers against the purchase criteria (i.e., product type, quantity, delivery terms, etc) and the resulting list is provided to the Buyer. Afterwards, the Buyer is enabled to select which suppliers the Buyer wishes to invite. Optionally, a confirmation e-mail message is automatically generated by the controller 20 for the Buyer at step 120, 124 to confirm the commencement and terms of the RFQ created. Additionally an email message is automatically sent to each of the invited Suppliers at step 122 to officially inform them of the RFQ invitation and the RFQ details at step 125. Included in each e-mail is a unique user name and password provided to the suppliers which are to be utilized by the selected suppliers to participate in to the procurement event. At this point, the Supplier may now prepare for the event and strategize for bidding, etc. Prior to this, as indicated at step 121, an administrator may be employed to implement further logic for verifying and approving the RFQ data and selected Supplier information.

Referring now to FIG. 4(b) at step 130, a Supplier logs in to the web-service and is provided with a web page providing a menu choice “Bid on RFQ” at step 133 enabling the supplier to view more details regarding the RFQ and the ability to post a competitive bid. At step 135, the supplier posts their bid information or re-key their bid information, e.g., in the case of a reverse auction where the supplier may desire to lower their bid in response to other suppliers' competitive bids. Next, at step 138, the supplier confirms the bid entered and submits it to the system at step 140. For the case of a reverse auction, a decision is made at step 145 to determine if the auction period has expired, i.e., the auction end date/time is equal to the current date/time. If the auction period has not ended, the Suppliers are enabled to re-visit their bids by logging on to the system at step 130 utilizing their unique id and password given, or keying in their new bid information at step 135. Otherwise, in the case of a more traditional bidding RFQ event, e.g., sealed-bid, no bids may be modified. Irregardless, after the RFQ event period has expired, the controller will automatically generate e-mails at step 147 including: an e-mail for the Buyer at step 148 which includes all of the bids submitted by every supplier which may be sorted by various criteria, e.g., by supplier, prices, etc.; and, an e-mail for each of the participating Suppliers at step 149 including the event results and their bid ranking as compared to other suppliers in accordance with the price transparency rules as set up by the Buyer when the RFQ was created as described herein at step 113, FIG. 4(a). It is understood that the Buyer may alternately enter into the service to view the bid results themselves.

At this point, the Buyer has received all of their bids and now will generate an order in a manual fashion as will be described, or, automatically, using intelligent rule-based agents that may select the winning bidder without manual intervention. Continuing to FIG. 4(c), there is depicted the step 150 of having the Buyer log into the web-service and, at step 153, providing the Buyer with a web page providing a menu choice “RFQ's in progress” which provides the Buyer with a list of all the RFQs that have been generated. At step 155, the Buyer selects the target RFQ that has been completed and reviews all of the bid information submitted by the suppliers. After selecting a supplier that the Buyer would like to purchase from, the Buyer selects an “order” link, which generates a notice to the service of the winning supplier for that RFQ. Furthermore, the controller downloads a web-based form that the Buyer fills out at step 159 to provide additional information for the supplier about the subsequent transaction, e.g., a purchase order number including delivery date(s), initial product shipment amount, preferred shipping method, etc. Then, at step 160, the Buyer submits the order, e.g., by clicking on a submit button provided in the web-based communication. Finally, at step 162, e-mails may be automatically generated that include: an optional e-mail 163 to the suppliers to notify them that they did not provide the winning bid and were not selected by the Buyer; an optional e-mail 165 to the Buyer confirming submission of the purchase order information and the supplier details; and, an e-mail 164 to the winning supplier to inform them that they were the winning supplier and can view the purchase order.

From the winning supplier's perspective, in response to receipt of their e-mail notifying them of their winning bid, they may now enter the web-service to accept the terms of the purchase order. Thus, continuing to FIG. 4(d), there is depicted the step 170 of having the Supplier log into the web-site and, at step 173, providing the Supplier with a web page providing a menu choice “Accept Orders” which provides the Supplier with a list of all the RFQs having associated supplier bids that were accepted by the Buyer. At step 175, the Supplier reviews the list of RFQ's and is enabled to accept the order, for example, by clicking on an “accept” link associated with the selected order, as indicated at step 177. At step 179, the supplier confirms the accepted order and, at step 180, will supply information for the Buyer such as the expected ship date of the purchased product. Continuing at step 181, the supplier will confirm the expected ship date, and at step 183, the controller will optionally automatically generate e-mails for the buyer and supplier including an e-mail for the Buyer at step 185 informing the buyer of the supplier's acceptance of the order and the anticipated product ship date indicated by the supplier; and, a confirmation e-mail for the supplier at step 186.

Continuing to FIG. 4(e), there is depicted the step 190 of having the Supplier log into the web-site and, at step 193, providing the Supplier with a web page providing a menu choice “Update Order Status” which provides the Supplier with a list of all the purchase orders that were accepted by the Supplier and their status. At step 194, the Supplier reviews the list of orders and is enabled to click on a selected order, as indicated at step 195. At step 196, the Supplier keys in the actual order ship and, at step 197, confirms the actual ship date of the order. Continuing at step 198, the web-site controller will automatically generate an email for the buyer informing the buyer of the actual product ship date indicated by the supplier at step 199.

It should be understood that, a tracking system may be implemented employing conventional order tracking techniques enabling buyers to ascertain the shipping status of the order.

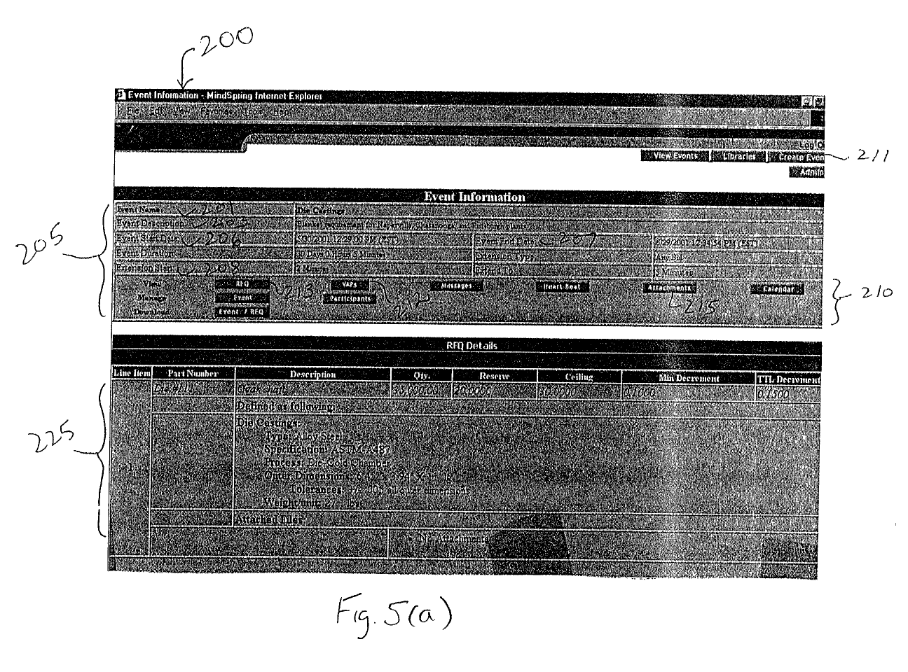

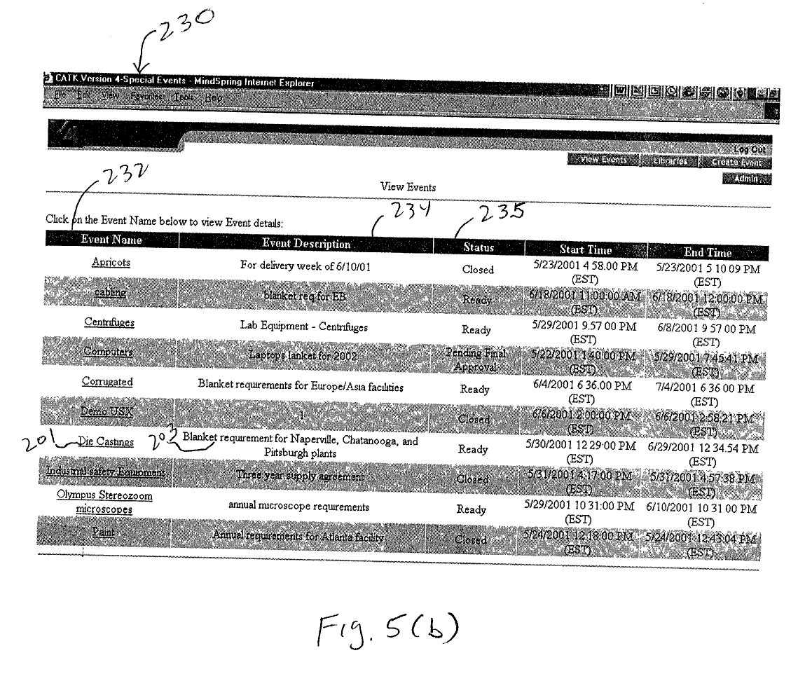

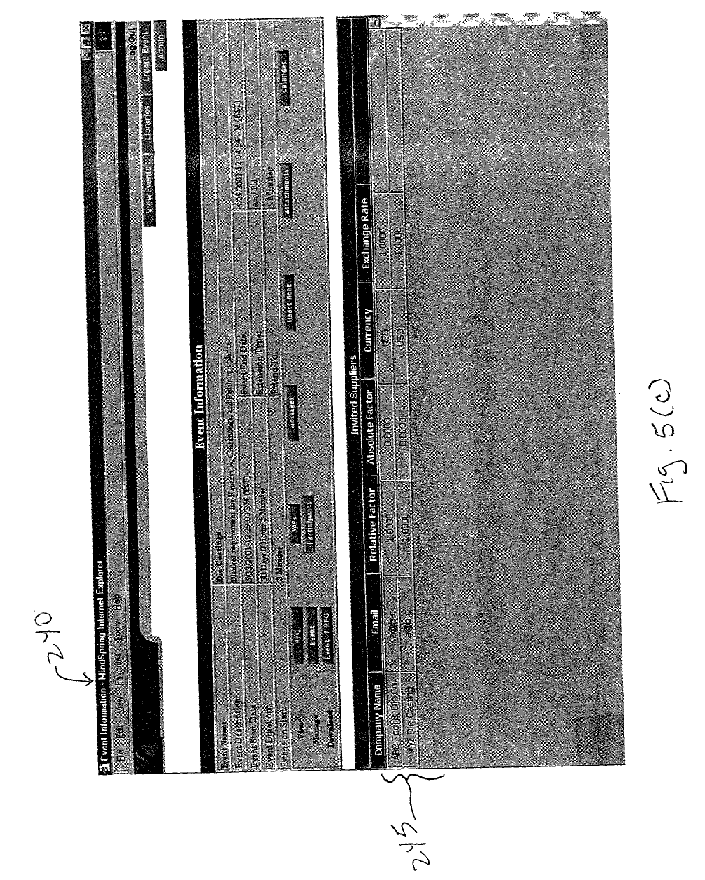

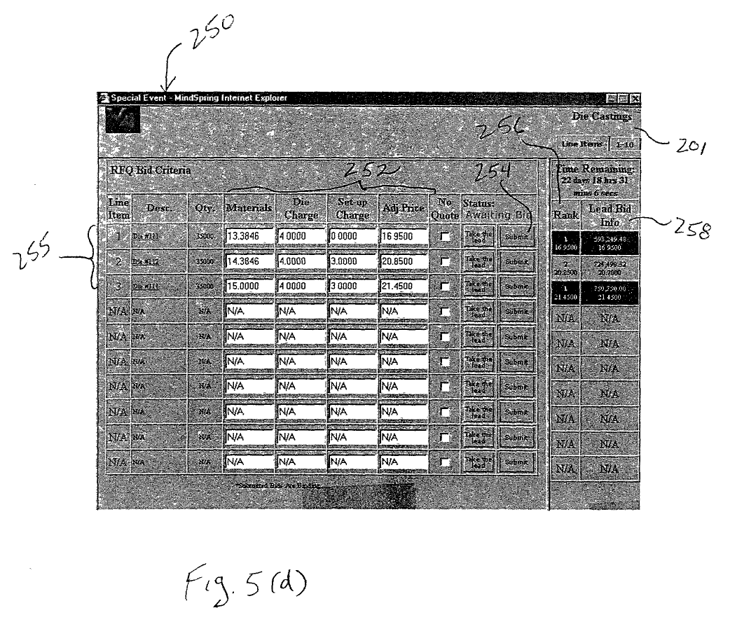

FIGS. 5(a) through 5(d) illustratively depict example web-based communications related to certain aspects of the procurement transaction process flow according to the invention. FIG. 5(a) illustrates an example web-page 200 downloaded to a Buyer showing a sample RFQ for a product “Die Castings” including a frame 205 detailing the event information including: event name 201, brief description of event 203, event start time 206, end time 207, and event type, and some of the rules governing the event such as an extension period 208, and various links 210 including link 215 selectable for uploading attachments. The web-page 200 further includes a frame 225 providing the RFQ details including a description of the materials. When provided to a Buyer registered with the web-site, the Buyer may select a “Create Event” button 211 that enables entry of the event information and RFQ details.

With regard to links 210, a View RFQ link 213 may be selected by a Buyer that enables the generation of a Buyer's list of RFQ's as shown in the example webpage 230 depicted in FIG. 5(b). In FIG. 5(b), the example web-page displays a table comprising the name(s) of bidding events 232 initiated by that Buyer and a short description of each event 234, and the current status 235 of each event. As shown in FIG. 5(b), the “Die Castings” event 201 is included in the event list 232.

Referring now to FIG. 5(c), there is illustrated an example web-page 240 downloaded to a Buyer showing a list of suppliers 245 that have been invited by a Buyer for a specific event (e.g., the “Die Castings” event of FIG. 5(a)) after preferred supplier matching and selection editing of the Suppliers. This page 240 may be accessed by the Buyer by selecting the event name 201 from the RFQ event list 232 of FIG. 5(b).

Referring back to FIG. 5(a), selecting a view VAPs link 212 enables the generation of the library of VAPs (Value Adjusted Pricing components) which might be utilized by a buyer during assembly of a new RFQ. Particularly, the VAP^{sm} comprises one or more algorithms that automatically convert bid parameters other than price that are provided by a supplier within a bidding event, into the buyer's perceived economic value of that parameter. That is, VAP^{sm} affords buyers the ability to transform (normalize) non-price parameters of a bidding event into a price adjustment that reflects (in price) the economic value of that attribute to the buyer. VAP^{sm} provides suppliers insight into the economic value a buyer places on non-price parameters. The buyer's perceived value is generated mathematically by applying the appropriate formulas (i.e., present value of money) to variables provided by buyer (cost of capital) that correspond to a supplier input (payment terms). By incorporating the use of Value Adjusted Pricing (VAP)^{sm} into bidding events, buyers are able to easily assess the total landed costs of each supplier's bid inputs. Those non-price bid parameters that may be specified as subject to Value Adjusted Pricing include, but are not limited to: payment terms; switching costs; lead time; duties; warranties; product life; product quality; delivery times; guaranteed supplier inventory levels; customer support/service; delivery terms; and, maintenance costs. Preferably, VAP^{sm} may either be incorporated into the bidding event thereby transforming each supplier's bid in real time or, be utilized to analyze suppliers' bids after a bidding event has ended.

FIG. 5(d) illustrates an example web-page 250 downloaded to a supplier showing the bidding window 250 as seen by a Supplier after the supplier has logged in and pulls up the RFQ they want to bid on, e.g., the “Die Castings” event 201. FIG. 5(d) particularly exemplifies a reverse auction bid type event for the “Die Castings” product whereby a supplier is enabled to submit and adjust his/her various bid quotations 252 associated with each RFQ event 255 that supplier is bidding in. Submission of a bid is accomplished by selecting submit button 254. As further depicted in web-page 250 is the rank 256 of that supplier related to other supplier participants and, the bid information 258 related to the lead bidder.

While the invention has been particularly shown and described with respect to illustrative and preformed embodiments thereof, it will be understood by those skilled in the art that the foregoing and other changes in form and details may be made therein without departing from the spirit and scope of the invention which should be limited only by the scope of the appended claims.

Having thus described our invention, what we claim as new, and desire to secure by Letters Patent is:

1. A method for conducting commercial transactions between buyer and sellers over a communications network, said method including the steps of:
a) maintaining a database of buyers and sellers, each buyer referencing an associated number of preferred suppliers that conducts business with that buyer, each said seller including descriptions of products capable of being purchased by said buyer;
b) providing communication over said network requesting initiation of a request for quotation (RFQ) bidding event for soliciting bids from suppliers of a requested product to be purchased by a buyer, said initiating including selecting from said database those preferred suppliers capable of providing said requested product based on said product descriptions;
c) in response to said initiation, automatically notifying selected suppliers of said RFQ bidding event and providing web-based communication enabling selected supplier submission of bids for the product to be purchased; and,
d) after a defined bidding event period, providing web-based communication to said buyer including said submitted supplier bids, and enabling selection of a supplier associated with a selected winning bid;
e) in response to said selection of a supplier with said winning bid, enabling said buyer and winning supplier to enter into a contract for completing said commercial transaction.

2. The method for conducting commercial transactions as claimed in claim 1, wherein said step e) of enabling said buyer and winning supplier to enter into a contract comprises the steps of:
automatically generating web-based communication to said buyer enabling said buyer to enter offer terms that enable completion of said commercial transaction in accordance with said winning bid; and,
providing web-based communication to said supplier enabling supplier acceptance of said offer terms, whereby said supplier is enabled to accept said offer and enable completion of said transaction.

3. The method for conducting commercial transactions as claimed in claim 1, wherein said step b) of requesting initiation of a RFQ bidding event for soliciting bids includes specifying a product to be purchased, an RFQ bidding event type; a bidding event duration, and rules governing solicitation of bids for said RFQ bidding event.

4. The method for conducting commercial transactions as claimed in claim 3, wherein said step of selecting from said database those suppliers capable of providing said product based on said product descriptions includes the step of: automatically comparing a requested product subject of said bid event against product descriptions provided in said database, and indicating matching suppliers capable of providing said specified product.

5. The method for conducting commercial transactions as claimed in claim 4, further including the step of enabling said buyer to edit out one or more matching suppliers from said automatic indication of matching suppliers.

6. The method for conducting commercial transactions as claimed in claim 1, wherein said step of selecting from said database those suppliers capable of providing said product based on said product descriptions includes the steps of: providing a list of all suppliers associated with said buyer; and
enabling manual selection of suppliers invited to solicit bids in said RFQ bidding event.

7. The method for conducting commercial transactions as claimed in claim 3, wherein said RFQ bidding event type includes one selected from the group of: reverse auction, sealed-bid, double-blind bid.

8. The method for conducting commercial transactions as claimed in claim 3, wherein for a reverse auction bidding event type, said step c) of enabling supplier submission of bids for the product to be purchased further includes the step of: enabling re-submission of new bids before ending of said bidding event duration.

9. The method for conducting commercial transactions as claimed in claim 2, wherein said offer terms includes requested delivery date for said product to be purchased and a preferred delivery method.

10. The method for conducting commercial transactions as claimed in claim 2, wherein in response to user selection of a supplier with said winning bid, said step e) further including the step of automatically generating electronic message to notify said supplier having the winning bid.

11. The method for conducting commercial transactions as claimed in claim 2, wherein said buyer is enabled to access only suppliers associated with that buyer from the database.

12. The method for conducting commercial transactions as claimed in claim 3, wherein said database maintained includes suppliers not associated with buyers who potentially have products that may be purchased by said buyers, said comparing step further including:
automatically comparing said requested product subject of said bid event against product descriptions provided in said database sold by said not associated suppliers; and indicating matching of not associated suppliers capable of providing said specified product.

13. The method for conducting commercial transactions as claimed in claim 1, wherein said step c) of notifying selected suppliers of said RFQ bidding event further includes the step of determining whether a supplier is to participate in said RFQ bidding event, said supplier participation determination is performed manually, or automatically by implementing rules-based agents.

14. The method for conducting commercial transactions as claimed in claim 1, wherein said step c) of enabling selected supplier submission of bids is performed manually, or automatically by implementing rules-based agents.

15. A system for conducting commercial transactions between buyer and sellers over a communications network, said system comprising:
a server device capable transmitting web-based communications over said communications network for receipt at web browser devices associated with buyers and suppliers, a communication being downloaded from said server including entries enabling a buyer to initiate a request for quotation (RFQ) bidding event for soliciting bids from suppliers of a requested product to be purchased by a buyer and, selecting preferred suppliers capable of providing said requested product based on a product description;
mechanism for automatically generating one or more electronic communications notifying selected suppliers of said RFQ bidding event, a communication being downloaded from said server to selected suppliers for enabling each selected supplier to submit a bid for the product to be purchased; and,
a mechanism for receiving said submitted supplier bids of said RFQ bidding event and providing a further communication to said buyer for enabling selection of a winning bid, said mechanism for automatically generating one or more electronic communications further notifying a selected winning supplier;
wherein response to selection of a supplier with said winning bid, said server generates further communications for enabling said buyer and winning supplier to enter into a contract for completing said commercial transaction.

16. The system for conducting commercial transactions as claimed in claim 15, further comprising:
a database including buyers and sellers, each buyer referenced with an associated number of preferred suppliers that conduct business with that buyer, each said seller including descriptions of products capable of being purchased by said buyer; and
a search mechanism for automatically selecting from said database those suppliers capable of providing said requested product based on said product descriptions.

17. The system for conducting commercial transactions as claimed in claim 16, wherein said buyer is enabled to access only suppliers associated with that buyer from the database.

18. The system for conducting commercial transactions as claimed in claim 15, wherein said server generated communications for enabling said buyer and winning supplier to enter into a contract include:
a web-based communication to said buyer enabling said buyer to enter and submit offer terms that enable completion of said commercial transaction in accordance with said winning bid; and, in response,
said server generating web-based communication to said supplier enabling supplier acceptance of said offer terms, whereby said supplier is enabled to accept said offer and enable completion of said transaction.

19. A program storage device readable by a machine, tangibly embodying a program of instructions executable by the machine to perform method steps for conducting commercial transactions between buyer and sellers over a communications network, said method steps comprising:
a) maintaining a database of buyers and sellers, each buyer referencing an associated number of suppliers that conducts business with that buyer, each said seller including descriptions of products capable of being purchased by said buyer;
b) providing communication over said network requesting initiation of a request for quotation (RFQ) bidding event for soliciting bids from suppliers of a requested product to be purchased by a buyer, said initiating including selecting from said database those suppliers capable of providing said requested product based on said product descriptions;
c) in response to said initiation, automatically notifying selected suppliers of said RFQ bidding event and providing web-based communication enabling selected supplier submission of bids for the product to be purchased; and,
d) after a defined bidding event period, providing web-based communication to said buyer including said submitted supplier bids, and enabling selection of a supplier associated with a selected winning bid;
e) in response to said selection of a supplier with said winning bid, enabling said buyer and winning supplier to enter into a contract for completing said commercial transaction.

20. The program storage device readable by a machine as claimed in claim 19, wherein said step e) of enabling said buyer and winning supplier to enter into a contract comprises the steps of:
automatically generating web-based communication to said buyer enabling said buyer to enter offer terms that enable completion of said commercial transaction in accordance with said winning bid; and,
providing web-based communication to said supplier enabling supplier acceptance of said offer terms, whereby said supplier is enabled to accept said offer and enable completion of said transaction.

21. The program storage device readable by a machine as claimed in claim 19, wherein said step b) of requesting initiation of a RFQ bidding event for soliciting bids includes specifying a product to be purchased, an RFQ bidding event type; a bidding event duration, and rules governing solicitation of bids for said RFQ bidding event.

22. The program storage device readable by a machine as claimed in claim 21, wherein said step of selecting from said database those suppliers capable of providing said product based on said product descriptions includes the step of: automatically comparing a requested product subject of said bid event against product descriptions provided in said database, and indicating matching suppliers capable of providing said specified product.

23. The program storage device readable by a machine as claimed in claim 22, further including the step of enabling said buyer to edit out one or more matching suppliers from said automatic indication of matching suppliers.

24. The program storage device readable by a machine as claimed in claim 19, wherein said step of selecting from said database those suppliers capable of providing said product based on said product descriptions includes the steps of: providing a list of all suppliers associated with said buyer; and
enabling manual selection of suppliers invited to solicit bids in said RFQ bidding event.

25. The program storage device readable by a machine as claimed in claim 21, wherein said RFQ bidding event type includes one selected from the group of: reverse auction, sealed-bid, double-blind bid.

26. The program storage device readable by a machine as claimed in claim 21, wherein for a reverse auction bidding event type, said step c) of enabling supplier submission of bids for the product to be purchased further includes the step of: enabling re-submission of new bids before ending of said bidding event duration.

27. The program storage device readable by a machine as claimed in claim 20, wherein said offer terms includes requested delivery date for said product to be purchased and a preferred delivery method.

28. The program storage device readable by a machine as claimed in claim 20, wherein in response to user selection of a supplier with said winning bid, said step e) further including the step of automatically generating electronic message to notify said supplier having the winning bid.

29. The program storage device readable by a machine as claimed in claim 21, wherein said database maintained includes suppliers not associated with buyers who potentially have products that may be purchased by said buyers, said comparing step further including:
automatically comparing said requested product subject of said bid event against product descriptions provided in said database sold by said not associated suppliers; and indicating matching of not associated suppliers capable of providing said specified product.

30. The program storage device readable by a machine as claimed in claim 19, wherein said step c) of notifying selected suppliers of said RFQ bidding event further includes the step of determining whether a supplier is to participate in said RFQ bidding event, said supplier participation determination is performed manually, or automatically by implementing rules-based agents.

31. The program storage device readable by a machine as claimed in claim 19, wherein said step c) of enabling selected supplier submission of bids is performed manually, or automatically by implementing rules-based agents.

32. A web-based service for facilitating purchase transactions of goods and services between buyers and sellers comprising:
a database of buyers and sellers, each buyer referencing an associated number of preferred suppliers that conducts business with that buyer, each said seller including descriptions of products capable of being purchased by said buyer;
controller device for receiving electronic request for quotation (RFQ) form provided by a buyer for initiating a RFQ bidding event for soliciting bids from sellers of a requested product to be purchased by said buyer, said controller selecting from said database those preferred sellers capable of providing said requested product based on said product descriptions and generating control commands for initiating and managing said RFQ bidding event;
server device responsive to controller commands for transmitting web-based communications over a communications network to both buyers and sellers, said communications including first communications for automatically distributing said RFQs to selected preferred suppliers sellers for inviting selected sellers to participate in said RFQ bidding event; second communications for receiving supplier bid quotations and automatically consolidating said bid quotations for communication to said buyer; and, third communications for providing said consolidated supplier quotations to said buyer to enable buyer selection of a winning bidder,
wherein, after selection of said winning bidder, said server providing fourth communications for enabling said buyer and winning supplier to enter into a contract for completing said commercial transaction.
